(19) United States
(12) Patent Application Publication
(10) Pub. No.: US 2018/0258976 A1
(43) Pub. Date: Sep. 13, 2018

(54) Self-Reactive Lock Nut Device With Highly Accurate Torque Coefficient

(71) Applicant: Shengyong Li, Shanghai (CN)

(72) Inventor: Shengyong Li, Shanghai (CN)

(21) Appl. No.: 15/973,174

(22) Filed: May 7, 2018

Related U.S. Application Data
(63) Continuation-in-part of application No. PCT/CN2017/000301, filed on Apr. 4, 2017.

(30) Foreign Application Priority Data
Apr. 20, 2016 (CN) 201610246658.X
Apr. 20, 2016 (CN) 201620334803.5

(51) Int. Cl. F16B 39/282; F16B 39/24; F16B 37/00

(52) U.S. Cl. CPC F16B 39/282; F16B 37/00; F16B 39/24

(57) ABSTRACT

A self-reactive lock nut device with highly accurate torque coefficient includes a Slotted nut, a Counteracting nut including a housing of Counteracting nut and a threaded ring. When the Slotted nut is tightened, the threaded ring is positioned between the housing of the Counteracting nut and the bolt to serve as a wedge ring effectively prevents the Slotted nut from loosening. The self-reactive lock nut device in the present invention can produce an accurate bolt pre-load when the friction coefficient is small between the bolts and nuts used in mechanical industry to prevent loosening during operation. This present invention is advantageous because it increases the reliability and safety of the connection between bolts and nuts during operation, especially petroleum and petrochemical industry, power generation like offshore wind power and nuclear electricity, speed railway construction and bridge construction. The mechanical structure of the self-reactive lock nut device can also significantly reduce the frequency of point inspection and maintenance.

This application is a continuation-in-part application of, and claims the benefit of priority to, PCT application no. PCT/CN2017/000301 filed on Apr. 4, 2017, which itself claims priority to China patent application no. 201610246658.X filed on Apr. 20, 2016 and China patent application no. 201620334803.5 filed on Apr. 20, 2016. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The present invention relates to a self-reactive lock nut device with highly accurate torque coefficient, which includes a Slotted nut, a Counteracting nut that including a housing of Counteracting nut and a threaded ring.

### BACKGROUND OF THE INVENTION

In mechanical industry, bolts and nuts are commonly used to facilitate the disassembling and maintenance of heavy equipment. Bolts and nuts can be fastened because there is a friction force between the threads of bolts and nuts, and between nuts and equipment parts, which will prevent the nuts from loosening. People usually try to prevent the loosening by increasing the friction coefficient between the bolts and nuts. For some lock nut products such as sawtooth nuts, Nylon nuts, double-sawtooth washer, the structures thereof are specially designed to increase the friction coefficient. When tightened under the same torque, the greater the deviation of the friction coefficient, the greater the pre-load deviation of the bolt, which renders the equipment unreliable. Some manufacturers try to increase friction coefficient after the bolts are tighten (by using thread-locking adhesives or latches, welding or destroying the threads), which causes the bolts to be loosening and it is difficult to check the status for the bolts to compensate the pre-load. In order to get a precise pre-load of the bolts, the methods of reducing friction coefficient and increasing torque coefficient are usually used, which seem to contradict with each other, and remains a need for a solution.

Most bolts are currently tightened via torque, which is to use torque tools to screw the nut to cause the position change between the nut and the bolt, and the bolt is thus forced to deform to produce a resilient pre-load. The deviations of the friction coefficients between nuts and surfaces of equipment parts (such as flange and body of equipment) will cause different resilient deformation forces to the nuts, so the pre-loads on the bolts are different. During the tightening process, a torque needs an anti-torque that will be against the supporting point near the bolt, and will tilt the bolt and generate unbalanced loading. When the nut is tightened, the torque of the nut will pass to the bolt but the bolt may not spin around at the same time, so a torsion stress may be generated.

If the bolts have imprecise torque or with torsion stress or small frictions coefficient, the nuts on the equipment may be loosening due to vibration, temperature or pressure differences. If the pre-load of the bolts cannot be limited within design requirements, some heavy equipment may fall down, petrochemical equipment may detonate. The operators of companies will often dispatch engineers to conduct status check periodically to determine whether the bolts and nuts are loosening, which is time-consuming. And in order to guarantee the safety for the engineers, equipment must be turned off during the check, which may incur some hidden costs. Therefore, there remains a need for a new and improved lock nut to overcome the problems stated above.

### SUMMARY OF THE INVENTION

The present invention provides a self-reactive lock nut device with highly accurate torque coefficient, wherein bolts having a precise pre-load will be tightened with highly precise torque coefficient between the Counteracting nut and Slotted nut. During the tightening process, the rough bottom surface of the Counteracting nut will engage with the parts of the equipment without generating relative movement. When tightening the Slotted nuts, the rough bottom surface of the Counteracting nut can serve as an anti-torque supporting point to ensure that the torque and anti-torque can work along the same axis and the bolt will be at the center without deviation. Furthermore, during the tightening process, the engagement between the threaded ring and the delicate tapered splines in the cone-shaped hole of the housing of Counteracting nut will help ensure that the ring will not spin around but instead move upward along the delicate tapered splines in the cone-shaped hole of the housing of Counteracting nut, and there will be no torsion stress during the tightening process. When the bolt is tightened, the threaded ring is positioned between the housing of Counteracting nut and the bolt as a wedge ring to effectively prevent the Slotted nut from loosening.

More specifically, the self-reactive lock nut device with highly accurate torque coefficient in the present invention may include a Slotted nut, a Counteracting nut, and a threaded ring configured to be disposed within the Counteracting nut. In one embodiment, the Slotted nut is round or hexagonal, with threads inside and a smooth surface at the bottom. The Counteracting nut can be dodecagonal or hexagonal that can be clamped by a reactive part, and the housing of Counteracting nut includes delicate tapered splines within the cone-shaped hole, a smooth surface on top, and a rough and slid resistance surface at the bottom. The threaded ring may have delicate splines outside and threads inside.

In another embodiment, the self-reactive lock features the fact that the smooth surface of the Counteracting nut and the smooth surface of the Slotted nut are in contact to generate a friction coefficient that is less than or equal to 0.15 when the nut is tightened.

It is noted that the delicate tapered splines in the cone-shaped hole of the housing of Counteracting nut and delicate splines outside of the threaded ring are in contact and complementary to form a tapered tolerance when the bolt is tightened, and the threaded ring is positioned between the delicate tapered splines in the cone-shaped hole of the Counteracting nut and the bolt to serve a wedge ring to effectively prevent the nut from loosening.

When tightening with torque, there will be a position change between the Slotted nut and the bolt to cause the bolt a resilient deformation. When a load is applied to the bolt, the bottom rough surface of the Counteracting nut will engage with corresponding equipment parts (such as flange or other parts) to prevent the Counteracting nut from spinning around, and the smooth surface of the Counteracting nut is in contact with the smooth bottom surface of the nut so a relatively small and even friction coefficient exists between the Counteracting nut and the Slotted nut, so as to gain the bolt a precise pre-load. The bottom surface of the Counteracting nut and the corresponding equipment parts (such as flange, boiling or other parts) are engaged and not to spin around. Meanwhile, the threaded ring engages with the housing of Counteracting nut via delicate tapered spline outside and inside, so the threaded ring will not spin around but instead move upward along the spline. The bolt coordinates with the ring via the thread. When the bolt is tightened, the threaded ring will not spin around, which forces the bolt to change position upward rather than spinning around, so no torsion stress is generated during the tightening process. When the Slotted nut is tightened, the tapered deviation between the threaded ring and the delicate tapered splines in the cone-shaped hole of the Counteracting nut will cause the threaded ring to be positioned between the delicate tapered splines in the cone-shaped hole of the Counteracting nut and bolt as a wedge ring to effectively prevent the bolt and the Slotted nut from loosening.

The invention is advantageous because the configuration of the mechanical structure in the present invention enables the bolts to obtain an accurate pre-load during traditional tightening process. In addition, there will be no torsion stress to prevent loosening, which will increase the reliability and safety of the connection between bolts and nuts in the operation of mechanical equipment, especially in petroleum and petrochemical industry, power generation like offshore wind power and nuclear electricity, speed railway construction and bridge construction. The mechanical structure disclosed in the present invention will also significantly reduce the frequency of point inspection and maintenance.

### BRIEF DESCRIPTION OF THE DRAWINGS

FIG. 1 is an exploded view of the self-reactive lock nut device in the present invention.

FIG. 2 is an assembled view of the self-reactive lock nut device in the present invention.

FIG. 3 is a sectional view of the self-reactive lock nut device in the present invention.

FIG. 4 is a schematic view of a saw-toothed pattern on the Counteracting nut in the present invention.

FIG. 5 is a schematic view when the self-reactive lock nut device is in use.

FIG. 6 is the exploded view of FIG. 5.

FIG. 7 is the sectional view of FIG. 5.

FIG. 8 is a schematic view of the anti-theft design of the Slotted nut in the present invention.

FIG. 9 is a sectional view of the housing of the Counteracting in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

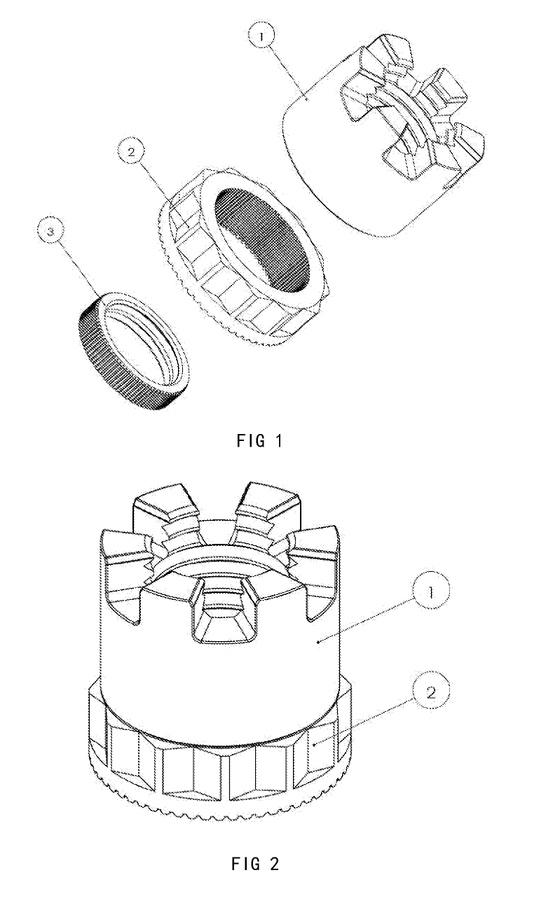

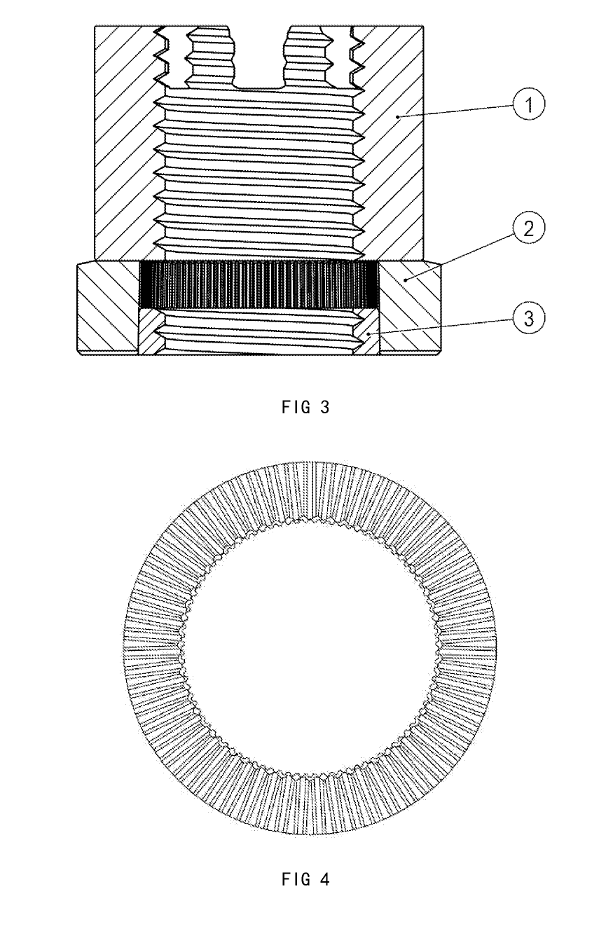

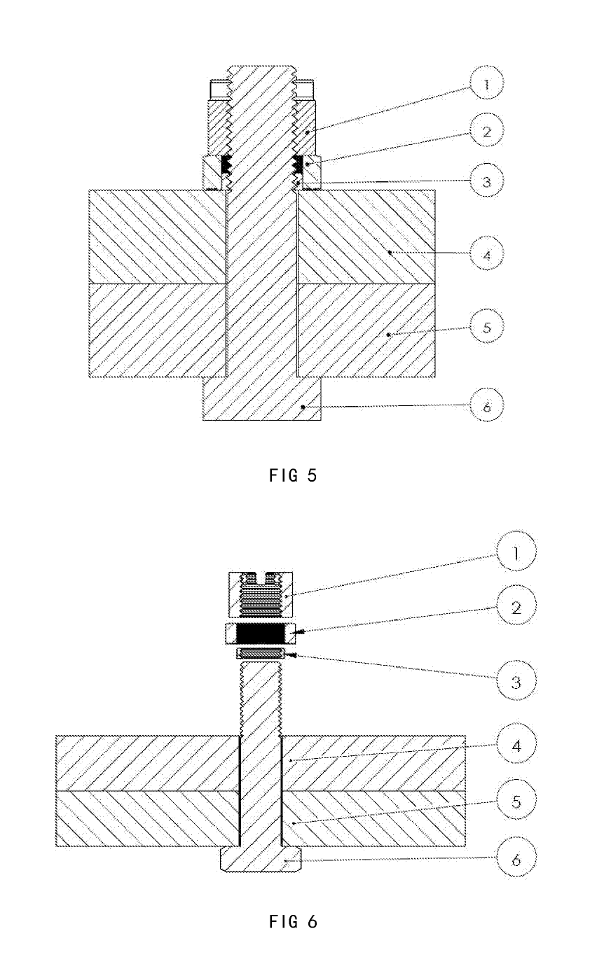

In one aspect, as shown in FIG. 1, a self-reactive lock nut device with highly accurate torque coefficient may include a Slotted nut 1, a Counteracting nut including a housing of Counteracting nut 2 with delicate tapered splines in the cone-shaped hole, and a threaded ring 3 with internal threads and external splines and engaging with the housing of Counteracting nut 2.

In one embodiment, the contact surface between the Slotted nut 1 and the housing of Counteracting nut 2 with delicate tapered splines in the cone-shaped hole inside is a smooth surface that is well-processed so that the change of the friction coefficient of the contact surface is insubstantial to affect the precision of deformation under the same torque. It is noted that there is a rough slid resistance pattern at a bottom portion of the Counteracting nut 2, and in one embodiment, the pattern is sawtooth. As shown in FIG. 4, the saw-toothed bottom of the housing of Counteracting nut 2 can be used to be in contact with a surface of a first equipment part 4 to increase the friction coefficient of the contact surface between the housing of Counteracting nut 2 and the first equipment part 4 to prevent the nut from spinning around when it is tightened.

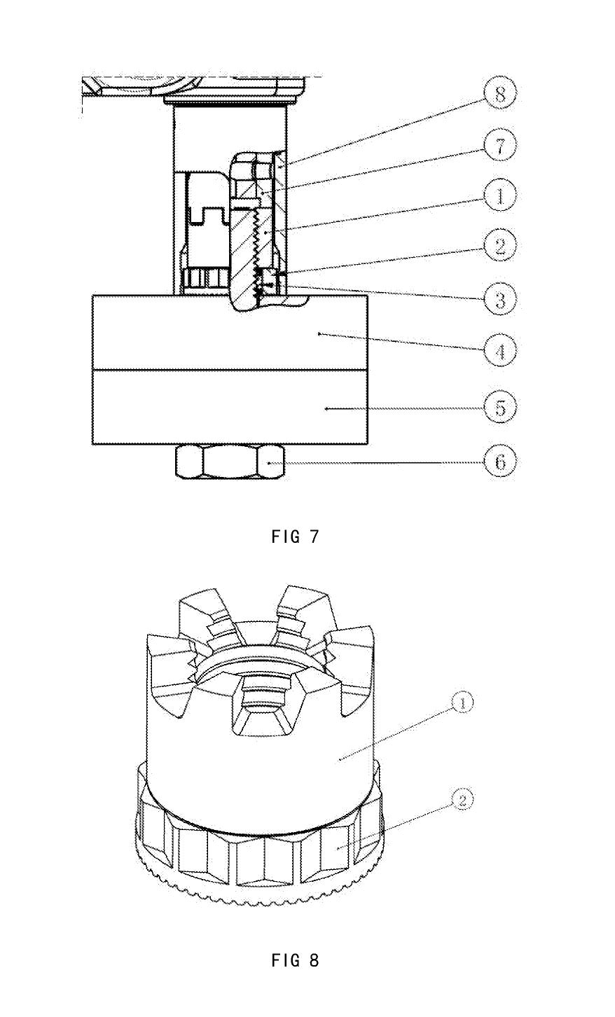

As is shown in FIG. 7, a bolt 6 is configured to pass through a through hole of each of the first equipment part 4 and a second equipment part 5 and to connect both equipment parts 4 and 5. The bottom threads of the bolt 6 engages with the Slotted nut 1 with inner threads and the threaded ring 3 with inner threads and splines. Also, the housing of Counteracting nut 2 with delicate tapered splines in the cone-shaped hole and saw-toothed anti-sliding bottom surface is in contact with the first equipment part 4. The outer surface of the housing of Counteracting nut 2 with delicate tapered splines in the cone-shaped hole further engages with a socket 8 to serve as an anti-torque supporting point. Through a castle-shaped torque socket 7, the Slotted nut 1 can be spun to drive the bolt 6 to change position to further drive the threaded ring 3 to slide upward along the delicate tapered splines in the cone-shaped hole of housing of Counteracting nut. It is important to note that the bolt 6, after a resilient deformation, a pre-load is generated to effectively connect the first equipment part 4 and second equipment part 5. The threaded ring 3 forms a wedge ring and is positioned between the delicate tapered splines in the cone-shaped hole of housing of Counteracting nut and the bolt 6 to maintain the pre-load of the bolt 6 against the loosening.

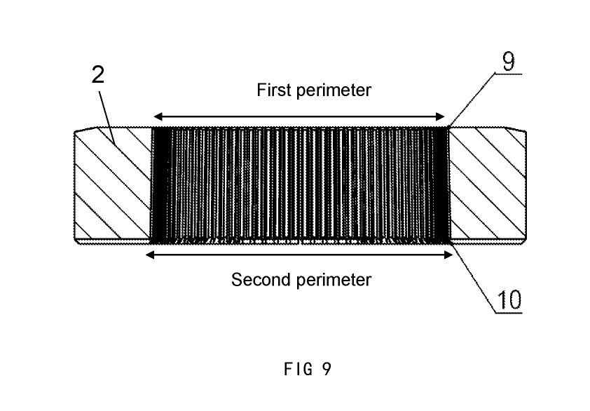

Further, the deformation of the Slotted nut 1 can be shown in FIG. 8. A predetermined angle can be made in a counterclockwise manner, which causes the wrench to slide, so as to effectively prevent the nut 1 from being stolen.

Further, the sectional view of the housing of the Counteracting nut 3 can be shown in FIG. 9. The cone-shaped hole is defined by a first perimeter 9 at a top surface of the Counteracting nut 3 and a second perimeter 10 at a bottom surface of the Counteracting nut 3, where the first perimeter 9 is less than the second perimeter 10. As discussed above, the cone-shaped hole includes a plurality of splines disposed between the top and bottom surfaces of the housing of the Counteracting nut.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A self-reactive lock nut device, comprising:
a slotted nut having threads inside with a slotted top portion and a smooth surface at a bottom portion;
a counteracting nut comprising a housing having a cone-shaped hole extending from a top surface to a bottom surface of the counteracting nut, wherein the cone-shaped hole has a first perimeter at the top surface and a second perimeter at the bottom surface, and wherein the first perimeter is less than the second perimeter, and wherein an inside of the cone-shaped hole comprises a plurality of splines;
a threaded ring configured to be inserted within the housing of the counteracting nut, and comprising threads inside and a second plurality of splines on an outside surface that are configured to cooperate with the plurality of splines of the counteracting nut; and
wherein the counteracting nut further comprises a smooth, top surface, and a rough, bottom surface.

2. The self-reactive lock nut device of claim 1, wherein the smooth, top surface of the counteracting nut and the smooth surface of the bottom portion of the slotted nut are in contact, and a friction coefficient there between is less than or equal to 0.15 when the self-reactive lock nut device is assembled about a bolt.

3. The self-reactive lock nut device of claim 1, wherein the cone-shaped hole having the plurality of splines and the second plurality of splines of the threaded ring cooperate with each other, and the threaded ring will move up and a taper deviation of them is produced when the slotted nut is tightened, and the threaded ring is positioned between the plurality of splines of the housing of the counteracting nut and the bolt as a wedge ring because a perimeter of the cone-shaped hole decreases when the threaded ring moves toward the slotted nut.

4. The self-reactive lock nut device of claim 1, wherein the rough, bottom surface of the counteracting nut provides a slid resistance surface.

5. The self-reactive lock nut device of claim 1, wherein the Slotted nut is round, hexagonal or equivalent.

6. The self-reactive lock nut device of claim 1, wherein a housing of the counteracting nut is dodecagon, hexagonal or equivalent which can be hold by a reaction device.

7. The self-reactive lock nut device of claim 1, wherein a perimeter of the cone-shaped hole decreases when the threaded ring move toward to the slotted nut to prevent loosening of the self-reactive lock nut device when the self-reactive lock nut device is assembled with a bolt.
